(19) United States
(12) Patent Application Publication
(10) Pub. No.: US 2010/0141428 A1
(43) Pub. Date: Jun. 10, 2010

(54) PERSONAL ALARM SYSTEM FOR LARGE GEOGRAPHIC AREAS

(76) Inventors: Stephen Mildenberger, Tangier (CA); Peter Miller, Chicago, IL (US)

Correspondence Address: SEYFARTH SHAW LLP, 131 S. DEARBORN ST., SUITE 2400, CHICAGO, IL, 60603-5803, US

(21) Appl. No.: 12/626,023

(22) Filed: Nov. 25, 2009

Related U.S. Application Data
(60) Provisional application No. 61/201,391, filed on Dec. 10, 2008.

(51) Int. Cl. G08B 1/08; H04B 1/69

(52) U.S. Cl. 340/539.11; 375/130; 375/E01.001

(57) ABSTRACT

A personal alarm system is provided that employs two different radio frequency subsystems to maximize the probability that the alarm message will reach its destination. The personal alarm sends its alarm message over a dedicated and unshared RF channel to minimize problems of RF interference and obstructed signal paths. The alarm message is then delivered to its destination over a separate spread spectrum, redundant and self healing communications network.

### RELATED APPLICATION

This application claims the benefit of priority of provisional application Ser. No. 61/201,391, filed Dec. 10, 2008. All of the disclosure of provisional application Ser. No. 61/201,391 is incorporated herein by reference.

### BACKGROUND OF THE INVENTION

Persons walking alone, particularly outdoors, particularly in high-crime urban areas, and particularly at night, are at risk of assault by unknown persons. Others may have medical conditions that could necessitate immediate assistance. Some may not be threatened but might observe an assault or an accident or a life threatening event such as a fire. A personal Alarm system is desirable that could cover a large indoor and/or outdoor area of up to several square miles, or an entire city. It would report the location and the identity of the person. A person who is a member of this system could then notify police or security staff immediately so that assistance could be directed to the location of the person activating an alarm device. Personal alarm systems with locating capability have been implemented in smaller areas, but technical cost obstacles have limited the implementation of existing systems over large urban or suburban areas.

The alarm device carried by a person to activate an alarm has presented one challenge to deploying a system for a large number of users. The device must be small and convenient to carry. If it is not, then many persons will leave it at home or at work and the alarm system will fail to protect these people. The alarm device must be very easy to use, so that it can be activated immediately and reliably in any emergency situation. Yet it must not be prone to accidental activation. Consider that a single accidental activation per year per alarm device, in a system with 20,000 alarm activation devices, would result in the police chasing 55 nuisance alarms per day. No alarm initiation device employing buttons or switches has come close to meeting an acceptable nuisance alarm rate for coverage of large areas and large numbers of users. U.S. patent application Ser. No. 12/574,516, filed Oct. 6, 2009, provides an alarm device that does not use a button for activation. It delivers an acceptably low rate of nuisance alarms for very large systems and it is also small and convenient to carry. This personal alarm also addresses the problem of activation in panic situations when untrained persons may panic and lose fine motor coordination, thereby being incapable of activating a button.

When a personal alarm system is deployed over a large geographic area, for example, two square miles, a large number of receiving devices must be installed to detect and locate a personal alarm transmission. A large and interconnected network of radio frequency (RF) receivers is required to detect the personal alarm transmission, and a communications network is needed to convey this alarm signal to a dispatch center from where assistance will be dispatched.

Systems have been offered that use GPS to locate a personal alarm. It is then possible to employ smaller number of receiving devices to detect the alarm signal. However, GPS is notably unreliable in urban areas where tall buildings and other structures block the signals, even when on the street. Inside buildings, such devices often fail to work at all. A dedicated RF network, if properly implemented, provides the highest probability of saving lives by reliably delivering alarm messages, with the user's location, to their intended destination.

When a duress alarm is initiated by a person in distress, the alarm system must communicate the alarm reliably and quickly to a security dispatch center, for example a police station, so that an immediate response always occurs. The process can be broken down into the following steps as shown in FIG. 1 of the drawings:
1. the signals from the personal alarm 1 carried by the person are captured by a receiving device in the node 3,
2. the node 3 will forward the alarm message to the alarm annunciator and display 5 in the security dispatch center,
3. the alarm message is presented in a clear and concise form that allows the dispatcher to deploy assistance immediately and accurately to the person in distress. The system may also initiate some other actions not directly involving the dispatcher, for example pointing cameras or sounding sirens. Finally,
4. the response team must provide the appropriate response 9 to assist the person who initiated the duress alarm:

In a personal alarm system that protects the lives of people, system reliability is critical. The alarm message must always be delivered from the alarm device to the dispatch center. The consequence of a failed alarm could be a lost life. The reliability of every segment of the alarm communication path is critical. If a single path fails, the alarm will not reach response personnel and the person in distress will not receive assistance. Existing alarm systems with locating capability cannot be scaled up to protect several square miles of a city with tens of thousands of protected persons, yet at the same time be able deliver an acceptable level of reliability at a reasonable cost. A new solution is needed that can reliably communicate RF personal alarm messages from the personal alarm to the dispatch center.

Each alarm transmission from the personal alarm must be received reliably by one or more alarm receivers. This is shown as path 2 in FIG. 1. Transmissions from the personal alarm to the alarm receiver must not be blocked by obstacles such as walls or buildings or trees or the user's body. They must not be jammed by other RF signals in the location where the person happens to be when initiating an alarm. Since a personal alarm that is acceptable and convenient to most users will be small, it will emit a relatively low power alarm signal. This adds to the challenge of ensuring reliable communications between the alarm device and the alarm receivers.

The personal alarm is carried by a person and may be located anywhere in the alarm coverage area when an alarm is activated. Interference from other RF systems sharing the same frequency at the time of the alarm cannot be predicted. Even if the entire coverage area were mapped for potentially interfering RF, new RF systems might be installed later. A more reliable solution is to operate the personal alarm in an FCC licensed RF band where no other systems are allowed to operate. One such RF band is the Public Safety band, located at 450-470 MHz in the United States. The FCC will assign a frequency (channel) that is not used by any other system in the geographic area where the assigned system operates. The personal alarm system is licensed for operation at a single frequency. Large numbers of RF devices in a personal alarm system could not use this single frequency at the same moment in time because simultaneous RF transmissions on the same frequency would interfere with each other and messages would be lost. Thus a single frequency is not suitable for a large network, but it is ideal for a personal alarm that only transmits a message in an emergency and is otherwise silent. Thousands of personal alarms in a large system could transmit at this same frequency. If one is activated, it has a clear channel. In a practical situation, personal alarms in different locations could operate simultaneously. For example, two personal alarms a city block apart would each be able to talk to separate RF receivers and would not interfere with each other. Other techniques such as multiple transmissions at random intervals can help to overcome interference if a small number of devices transmitted from the same location, for example if several persons activated personal alarms to report a fire.

Although operation in an FCC licensed and unshared RF band is the most reliable solution, very few systems operate this way. Most personal alarms operate in a shared RF band. Alarm transmissions are subject to the RF interference from other systems that happen to be in the vicinity of the personal alarm when it is activated. Because the location of the personal alarm cannot be predicted, acceptable reliability is best achieved by using a clear dedicated RF channel for the personal alarm.

In the next part of the alarm communications path, labeled 4 in FIG. 1, the received alarm messages from the personal alarm must be transported from the alarm receivers to the dispatch center without message loss or errors en route. In a personal alarm system that locates the user, transmissions may be received by as many as 20 or 30 receivers. RF communication of alarms from the alarm receivers to the dispatch center must be reliable in the presence of physical obstacles such as buildings and trees. The many RF systems that share the air waves in urban environments will add to the challenge of reliability. To prevent a failed component from preventing the delivery of a life-saving alarm message, the network will need to employ an appropriate level of redundancy. Personal alarm systems currently being marketed could not meet these criteria when scaled up to cover large geographic areas.

A single FCC assigned operating frequency that is optimum for the personal alarm does not work for the network. Network traffic could momentarily be high as the network delivers multiple received messages for a single alarm, and higher if alarms occur at the same time from different parts of the coverage area. Diagnostic messages also must be handled for perhaps thousands of RF transceivers 7 to ensure they are operating properly. These messages cannot all be handled on the same single frequency simultaneously, so a single FCC assigned frequency is not a solution. Although one could conceive of technical solutions that would combine many messages into one RF frequency, for example by time multiplexing of the messages, no practical solutions are available that could be implemented to provide a large, cost-effective, and reliable network.

Because the RF receivers 6 and network transceivers 7 are in fixed locations, and because they will have a reliable and continuous source of power, it is possible to resolve issues of RF interference and of communications paths being blocked. For example, it is trivial to monitor and report the level of RF interference at each point in the network. If a location encounters interference or a detrimental change in background RF levels, maintenance staff can be notified to address and resolve the issue. Thus the network can defend itself from RF interference. This solution is not possible for the personal alarm 1, which changes location as the user moves around. Communications paths between alarm receivers 6 can also be monitored and typically are slow to change. If a tree grows larger or a new structure is built, reduction of signal strength will be reported by the network and can be resolved by moving a node 3 or adding a node 3 to the network.

It is, therefore, an object of the present invention to provide an alarm system that can be expanded to handle numerous alarms and to cover geographic areas up to several square miles.

Another object of the present invention is to provide an alarm system that is highly reliable and economical.

Other objects and advantages of the invention will become apparent as the description proceeds.

### BRIEF DESCRIPTION OF THE INVENTION

In accordance with the present invention, two separate radio frequency subsystems are combined to convey an alarm message from the personal alarm to the dispatch center. This provides a system that can be expanded to handle many thousands of personal alarms and to cover geographic areas up to several square miles. Yet the system is able to deliver life saving alarm messages with very high reliability. This solution is also economical for small personal alarm systems so it can be employed in many applications.

In an illustrative embodiment, an alarm system that is provided for personal alarm coverage comprises an alarm initiation device and an alarm receiver. A first radio frequency subsystem is provided using a licensed and unshared band for conveying an alarm message from the alarm initiation device to the alarm receiver. A second radio frequency subsystem is provided. The second radio frequency subsystem is different from the first radio frequency subsystem, and is used for relaying the alarm message to an emergency dispatch center. The second radio frequency subsystem comprises a redundant and self-healing spread-spectrum mesh radio frequency alarm network of network transceivers.

“Self-healing” means that the network recognizes a problem in delivering a message through a network path and the network automatically determines alternate paths so that the network continues to function when a failure occurs.

In one embodiment, the alarm receiver of the alarm system of the present invention comprises a plurality of transceivers operating in the FCC public safety band.

In one embodiment, the transceivers of the alarm system of the present invention use the ZigBee protocol.

In one embodiment, the transceivers of the alarm system of the present invention are operable, via network transmission paths, to relay alarm messages to an alarm annunciator to display and annunicate the alarm message.

In one embodiment of the present invention, a plurality of nodes are provided for receiving the alarm signal and for relaying the received alarm messages to an alarm annunciator and display.

The nodes are installed close enough together to provide redundancy of communication paths.

A more detailed explanation of the invention is provided in the following description and claims, and is illustrated in the accompanying drawings.

### BRIEF DESCRIPTION OF THE DRAWINGS

FIG. 1 is a diagrammatic view of a typical alarm process in a large area personal alarm system.

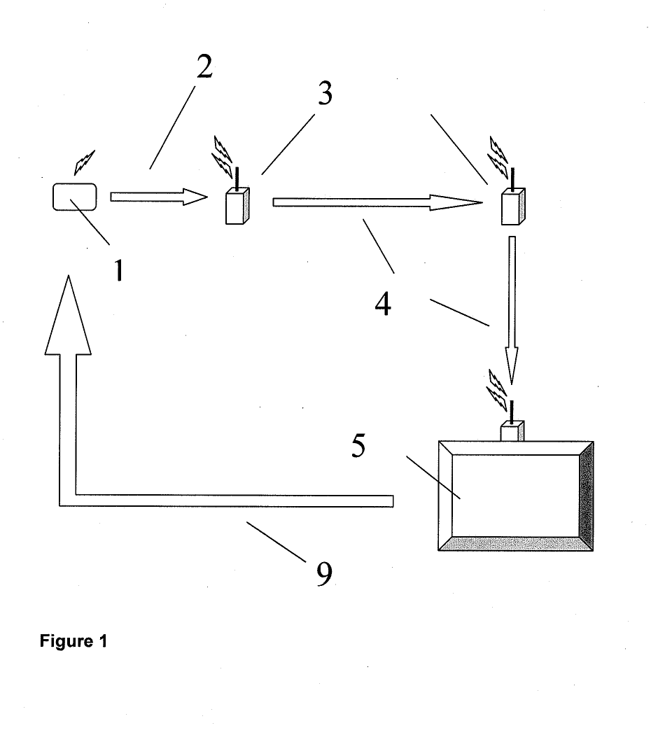

FIG. 2 is a diagrammatic view of the building blocks and communication parts of a personal alarm system constructed in accordance with the principles of the present invention.

FIG. 3 is a diagrammatic view of a personal alarm system constructed in accordance with the principles of the present invention, built with the blocks of FIG. 2.

### DRAWINGS REFERENCE NUMBERS

1—Personal alarm
2—Communication path from personal alarm to node
3—Node
4—Communication path between nodes
5—Alarm annunciator and display
9—Response to bring assistance to the person signaling an alarm
11—Personal alarm
12—Communication path from personal alarm to node
13—Node
14—Communication path between nodes
15—Alarm annunciator and display
16—Alarm receiver in node
17—Network transceiver in node
18—Serial link between alarm receiver and network transceiver

### DETAILED DESCRIPTION

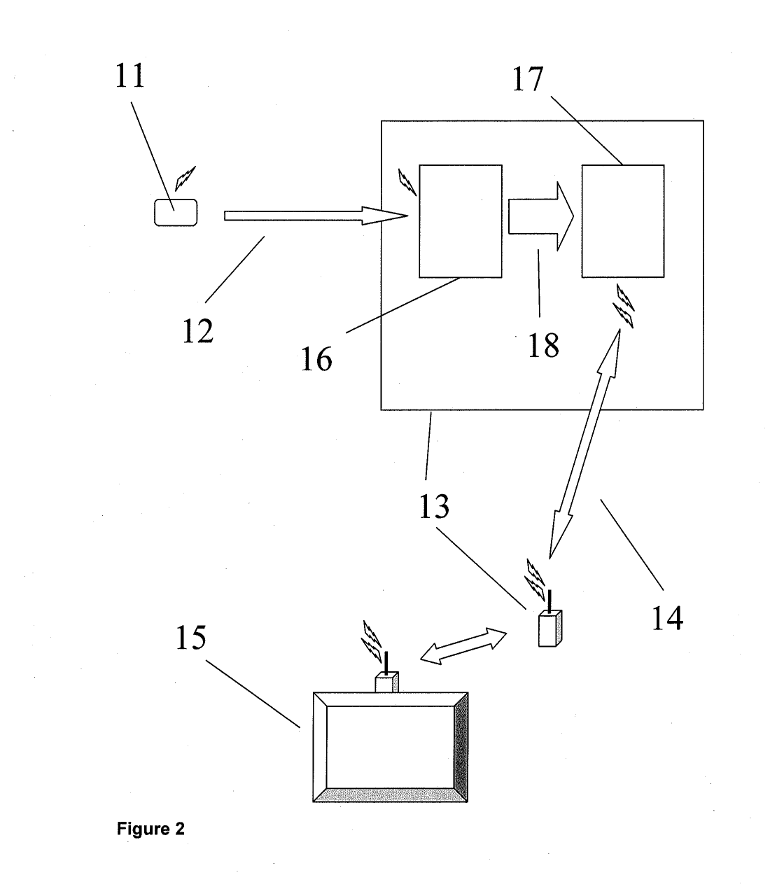

FIG. 2 is a simplified block diagram of the elements of an alarm system that can support many thousands of personal alarms 11 and can protect large urban areas of several square miles. The alarm process begins when personal alarm 11 is activated by a user in distress and issues an RF alarm message. This alarm message is processed by the first RF subsystem consisting of the personal alarm 11, the alarm path 12, and the alarm receiver 16. It is then transferred via a serial link to the second RF subsystem consisting of transceivers 17 and alarm communications paths 14, ending at the alarm annunciator and display 15.

In the first alarm subsystem with RF communication path 12, the alarm message is generated by the personal alarm 11. The personal alarm 11 has an RF transmitter that complies with FCC part 90 for transmission on an assigned and unshared RF frequency. The corresponding receivers 16 in node 13 meet the same specifications. To use the FCC public safety band in the USA at 450 MHz to 470 MHz, it had been necessary to create more or less custom designs for transmitters and receivers that would comply with FCC requirements. In recent years this has become less of a challenge. As an example, although no limitation is intended, the ADF7021N transceiver chip from Analog Devices, Inc. meets this FCC specification with very few external components. It can be used as both the transmitter in the personal alarm 11 and the receiver 16 in the first RF communications subsystem.

The alarm transmission from the Personal Alarm 11 is received by a plurality of alarm receivers 16 installed throughout the protected area. In outdoor areas, these might be located two to three along a city street. Inside a building or a parking garage, the density of receivers 16 would be higher and would depend on the configuration and RF characteristics of the building. Because the RF communications path is not shared, relatively low power transmissions can be received. Multipath issues can be addressed with known techniques such as orthogonal antennas at the transmitter or receiver. The RF attenuation effects of structures and obstacles can be accommodated by installing adequate nodes 3 with RF receivers 16 to ensure that no alarm message is lost. This always requires some testing and reconfiguring of node locations on site, since it is not possible to accurately model the effects of large buildings on RF signals.

After the alarm message is received by the alarm receiver 16, it is passed to the second part of the network via a serial port 18. The acquisition of the data from the alarm receiver 16 and the transfer of this data to the second RF subsystem is handled by a simple microcontroller. This could be a separate device, for example, (although no limitation is intended) the MSP430C11 offered by Texas Instruments, or a microcontroller might be included in some configurations available to implement the second RF subsystem.

The second RF subsystem includes a plurality of RF transceivers 17 that communicate the alarm message via RF paths 14 to an alarm display and annunciator 15. It is separate from the first RF subsystem and operates in a very different mode to accommodate the unique requirements for reliably delivering alarm messages over longer distances and from a large geographic area. The serial link provides a bridge between the two RF subsystems. Prior art personal alarm systems have not addressed the different requirements and constraints of these two RF subsystems and as a result have failed to deliver a reliable and cost effective personal alarm system to cover large areas and protect large numbers of users.

The second RF subsystem is a spread spectrum mesh network. A mesh network is one in which an array of RF transceivers 17 are able to work as a subsystem to pass messages from one transceiver 17 to another. Generally, a message from any originating device attached to a transceiver 17 in a mesh network can be sent to a destination device attached to any other transceiver 17 in the mesh network. The destination is encoded in data attached to the message. For the alarm system described here, all alarm messages have the same destination, that is, the dispatch center that will send out staff to provide assistance.

A well designed mesh network provides built-in redundancy so that if any transceiver 17 fails, the alarm signal is not lost. It includes more transceivers 17 than are needed for communication of an alarm message under ideal circumstances. For example the transceivers 17 might be installed with adequate density so that each transceiver 17 can communicate with three other transceivers 17. Then if one path is lost, the transceiver 17 has two other alternative paths though which to forward a message to its destination.

Failures are recognized and the alarm messages are rerouted through other network paths 14 to the destination in the event of a failure. The ability to determine network path 14 failures and to recover from them by establishing alternate RF network paths 14 is known as “self healing.” In particular, networks using the ZigBee protocol or similar mesh network protocols are “self-healing” in the face of one or more failed transceivers 17 or in the presence of RF interference. These types of networks can be configured to employ many transceivers 17, making them easy to use for large systems. In addition to dealing with device failures, RF interference and signal path obstructions can be addressed by rerouting network paths 14 until the problems are corrected.

Several manufacturers have off-the-shelf hardware that implements the ZigBee protocol. Chip sets are available, from firms such as Ember, in Boston Mass. Some manufacturers have implemented ZigBee subsystems using chip sets. Digi International is one such company. Digi International offers a line of ZigBee modules that work “out of the box” to relay messages to a destination computer. Their boards include microcontroller, power supply, and USB implementation of the serial port. Digi International also offers a variant of the ZigBee protocol, Digimesh, that is more suited to some configurations.

Although many mesh networks, some of them proprietary, have been built, ZigBee is particularly well suited to personal alarm system applications because it is designed for applications requiring very low data rates. ZigBee devices are relatively low cost and draw very little power, making them economical for large area urban installations where solar power and batteries will often power the devices. With its redundancy, its self-healing ability, and its capability to be expanded into large numbers of transceivers 17, ZigBee or a similar protocol such as Digimesh, or one of a number of similar but proprietary mesh network protocols, provides the best solution for the second RF subsystem.

In FIG. 2, network transceiver 17 relays each alarm message via network transmission paths 14 and through one or a plurality of network transceivers 17, to an alarm annunciator 15 to display and annunciate the alarm message. In a complete system, a plurality of nodes 13 will receive the alarm signal and relay the received alarm messages to the annunciator and display 15.

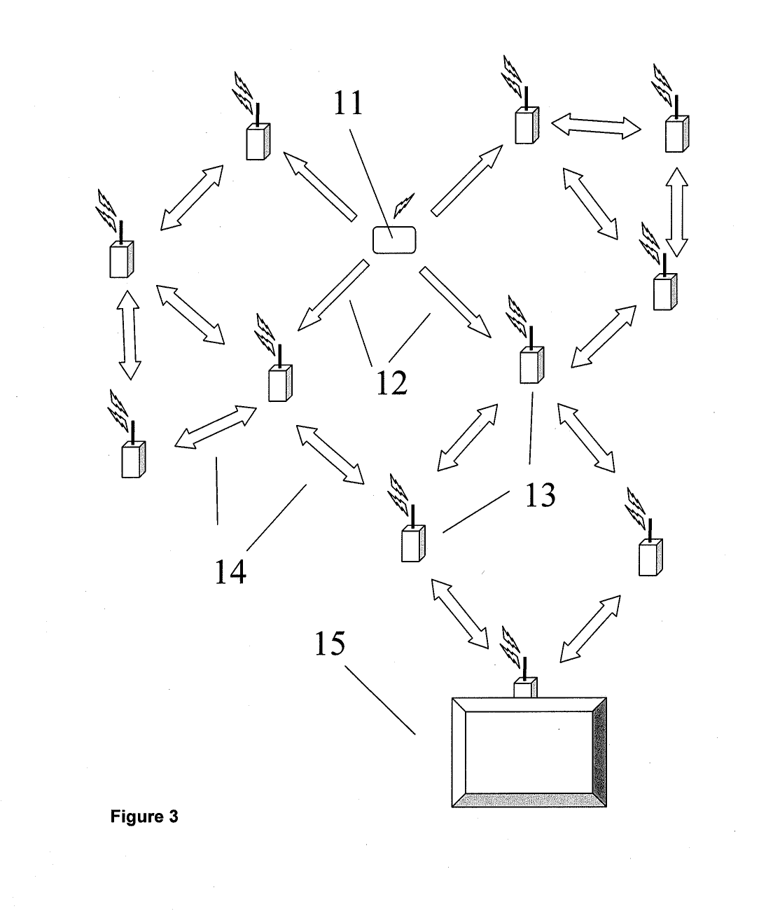

FIG. 3 shows an example of a network with a plurality of nodes 13. The nodes 13 are installed close enough together to provide redundancy so that if one transceiver 17 fails or encounters interference from unwanted RF transmissions or signal path obstructions, alternate communications paths 14 can be found to successfully transport alarm messages. The distance between nodes 13 is also small enough so that if any alarm receiver 16 fails, the alarm transmission from personal alarm 11 will be received by a sufficient number of other receivers 16 to ensure the reporting of an alarm message and its location. In this way the system provides full redundancy of communications paths. To provide full system redundancy, alarm annunciator 15 is configured with redundant RF transceivers 17 and redundant electronic subsystems.

It can be seen that a novel personal alarm system for large geographic areas has been provided which can be expanded to handle many thousands of personal alarms and to cover geographic areas up to several square miles with high reliability and efficiency. Although an illustrative embodiment of the invention has been shown and described, it is to be understood that various modifications and subsequent substitutions may be made by those skilled in the art without departing from the novel spirit and scope of the present invention.

1. An alarm system for providing personal alarm coverage, which comprises:
an alarm initiation device;
an alarm receiver;
a first radio frequency subsystem using a licensed and unshared band for conveying an alarm message from said alarm initiation device to said alarm receiver;
a second radio frequency subsystem, that is different from the first radio frequency subsystem, for relaying the alarm message to an emergency dispatch center;
said second radio frequency subsystem comprising a redundant and self-healing spread-spectrum mesh radio frequency alarm network of network transceivers.

2. The alarm system of claim 1, in which said alarm receiver comprises a plurality of transceivers operating in the FCC public safety band.

3. The alarm system of claim 1, in which said network transceivers use the ZigBee protocol.

4. The alarm system of claim 1, in which said network transceivers are operable, via network transmission paths, to relay alarm messages to an alarm annunciator to display and annunicate the alarm message.

5. The alarm system of claim 1, including a plurality of nodes for receiving the alarm message and relaying the received alarm messages to an alarm annunciator and display.

6. The alarm system of claim 5, in which the nodes are installed close enough together to provide redundancy of communication paths.

7. An alarm system for providing personal alarm coverage, which comprises:
an alarm initiation device;
a plurality of alarm receivers;
a first radio frequency subsystem using a licensed and unshared band for conveying an alarm message from said alarm initiation device to a said alarm receiver;
a second radio frequency subsystem, that is different from the first radio frequency subsystem, for relaying the alarm message to an emergency dispatch center;
said second radio frequency subsystem comprising a redundant and self-healing spread-spectrum mesh radio frequency alarm network of network transceivers;
said network transceivers using the ZigBee protocol;
a plurality of nodes for receiving the alarm message and relaying the received alarm messages to an alarm annunciator and display.

8. The alarm system of claim 7, in which the nodes are installed close enough together to provide redundancy of communication paths.
